(19) United States
(12) Patent Application Publication
(10) Pub. No.: US 2008/0155251 A1
(43) Pub. Date: Jun. 26, 2008

(54) ELECTRONIC PROTOCOL CONVERTER

(75) Inventor: Tony Antonucci, Schaumburg, IL (US)

Correspondence Address: BANNER & WITCOFF, LTD., TEN SOUTH WACKER DRIVE, SUITE 3000, CHICAGO, IL, 60606, US

(73) Assignee: DIGITAL DYNAMICS SOFTWARE, INC., Schaumburg, IL (US)

(21) Appl. No.: 11/616,134

(22) Filed: Dec. 26, 2006

(51) Int. Cl. H04L 9/00

(52) U.S. Cl. 713/153

(57) ABSTRACT

Systems and methods are provided allowing two or more electronic devices that each operate under different protocols to communicate. In one embodiment, a gateway component is configured to convert electronic signals or messages using a first protocol to messages or electronic signals in another protocol. In one such embodiment, the gateway may asynchronously transmit converted communications between an electronic device and a host, without neither the electronic device nor the host device being aware of the gateway component and without noticeable delay in operation of the electronic device. In another embodiment, the system may include a component utilizing a first protocol to communicate with the electronic device and another component using a second protocol to communicate with a host device.

### BACKGROUND

Innovation in the electronic arts has rapidly increased in recent years. With such a rapid expansion, there have been many advances that provide new devices, more options, and more efficient methods of utilize existing devices. A problem, however, exists when a large quantity of manufacturers only utilize specific protocols that are not compatible with other protocols of similar devices or components which the electronic device must communicate with.

The gaming industry, for example, currently utilizes several protocols in electronic devices, such as electronic slot machines. The various protocols may be chosen based upon a myriad of factors, including: geographic location, regulation by government agencies, security concerns, existing licensing agreements and hardware device requirements. Regardless of the reason(s), a financial burden is placed on the manufacturers of such devices, who may be forced to test machines operating under different protocols and market different machines in various markets among other concerns. Having so many different protocols also limits the availability of certain devices to the end users. Thus, consumers often do not have an adequate choice of gaming devices or may even be forced to absorb the costs of providing the software and hardware to support different systems.

In the past, simple converters could be placed in between two electronic devices operating under different protocols. These simple converters would merely “translate” each incoming single message using a first protocol into a single outgoing message in another protocol. Unfortunately, with modern electronic devices several protocols can not be configured to communicate with another protocol on a 1:1 ratio. Further modern protocols have relatively short time-out periods where the electronic device will determine that a host device is not connected after not receiving a response to a query a fraction of a second. These and other problems have left a void in the electronics industry that does not allow a electronic devices using varying protocols to communicate, even with the aid of conventional converting systems.

### SUMMARY

Aspects of the invention relate to systems and methods for allowing two or more electronic devices that each operate under different protocols to communicate. In one embodiment, a gateway component is configured to convert electronic signals or messages using a first protocol to messages or electronic signals in another protocol. In one such embodiment, the gateway may asynchronously transmit converted communications between an electronic device and a host, without neither the electronic device nor the host device being aware of the gateway component and without noticeable delay in operation of the electronic device.

In yet another embodiment, the system may include a component utilizing a first protocol to communicate with the electronic device and another component using a second protocol to communicate with a host device. In yet further embodiments, the components and the gateway are within a single housing. In yet other embodiments, the components are each distant from the gateway and may include computer-readable mediums for storing and executing instructions without requiring the gateway to process or convert some messages or electronic signals. In one such embodiment, the components indirectly communicate through a communication channel carrying unrelated information, such as an intranet.

These and other advantages will become apparent from the following detailed description when taken in conjunction with the drawings. A more complete understanding of the present invention and the advantages thereof may be acquired by referring to the following description in consideration of the accompanying drawings, in which like reference numbers indicate like features. The invention is being described in terms of exemplary embodiments. Numerous other embodiments, modifications and variations within the scope and spirit of the appended claims will occur to persons of ordinary skill in the art from a review of this disclosure.

### BRIEF DESCRIPTION OF THE DRAWINGS

FIG. 1 shows an exemplary system for implementing select embodiments or portions of select embodiments of the invention.

FIG. 2 shows an exemplary electronic protocol converter system according to one embodiment of the invention.

FIG. 3 is an exemplary flow diagram of a method for converting electronic signals between two different protocols according to one embodiment of the invention.

FIG. 4 shows exemplary electronic protocol converter systems according to further embodiments of the invention.

### DETAILED DESCRIPTION

Simplified Computing Device Description

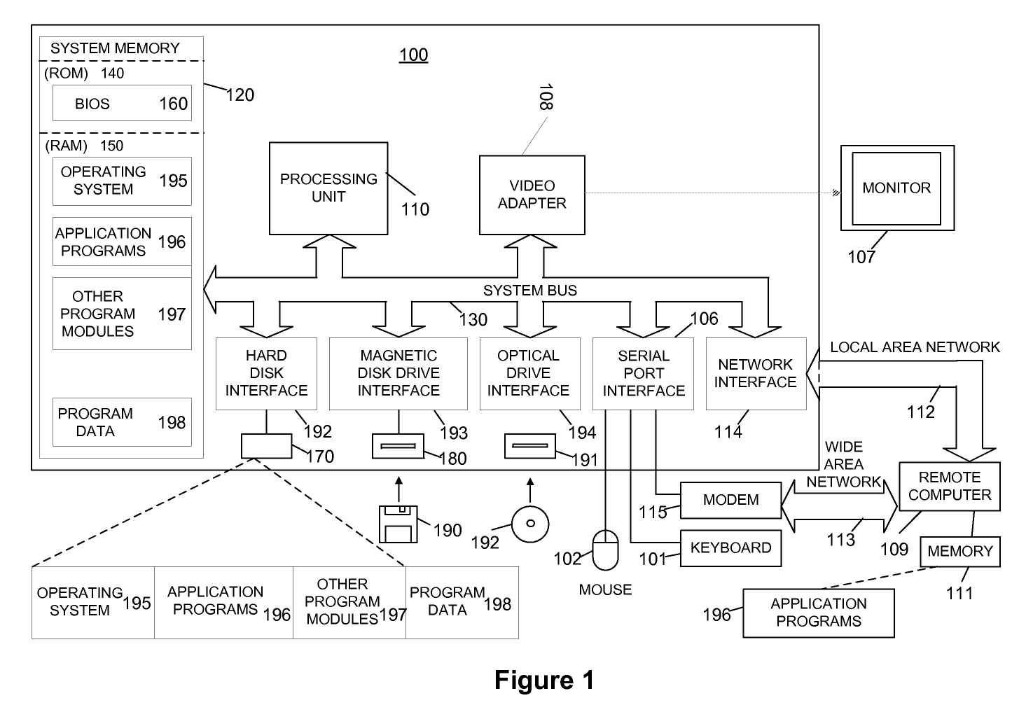

With reference to FIG. 1, an exemplary system for implementing select embodiments or portions of select embodiments includes a computing device, such as computing device 100. Computing device 100 may serve as one or more of the following: a gateway component, a host protocol component, and/or an engine protocol component, which will be described in detail below.

FIG. 1 is a functional block diagram of an example of a conventional general-purpose digital computing environment that can be used in connection with the methods and systems of the present invention. In FIG. 1, a computer 100 includes a processing unit 110, a system memory 120, and a system bus 130 that couples various system components including the system memory to the processing unit 1 10. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). The illustrated computer 100 includes an optional PCMCIA interface 103 that may connect at least one embodiment of an input device according to the present invention to the computer 100. Further still, these devices may be coupled directly to the system bus 130 via an appropriate interface (not shown). A monitor 107 or other type of display device is also connected to the system bus 130 via an interface, such as a video adapter 108.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are illustrative and other techniques for establishing a communications link between the computers can be used.

The existence of any of various well-known protocols such as TCP/IP, Ethernet, FTP, HTTP, Bluetooth, IEEE 802.11x and the like is presumed.

### Description of Illustrative Embodiments

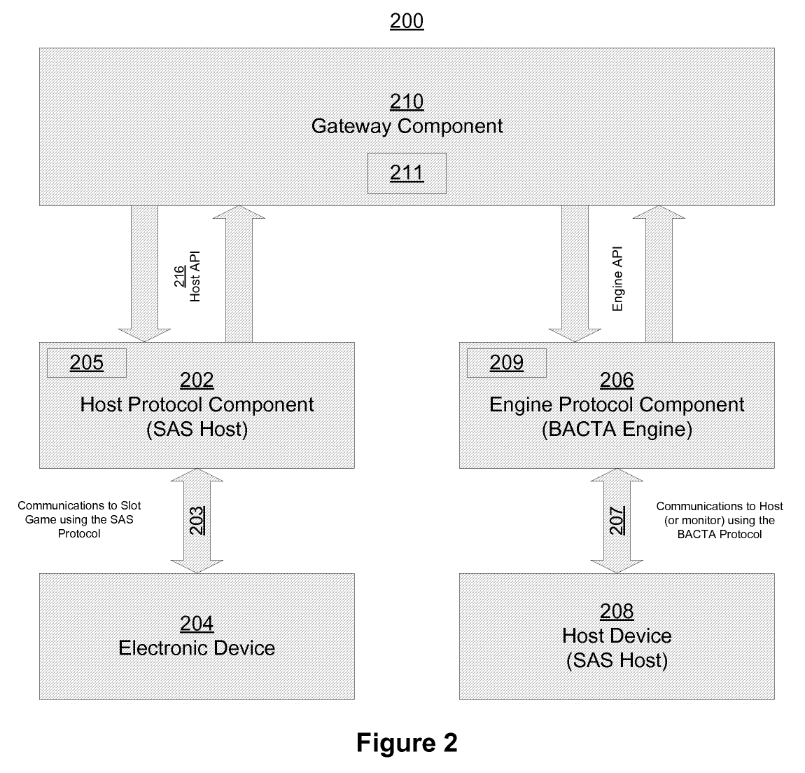

Embodiments of the invention will first be described in relation to the structure of protocol conversion systems. Next, exemplary methods of utilizing exemplary structures of the protocol conversion systems will be provided. FIG. 2 shows an illustrative protocol conversion system according to one embodiment of the present invention. As seen in FIG. 2, protocol conversion system 200 comprises host protocol component 202 in communication with electronic device 204. As used herein, an electronic device includes any device having a computer-readable medium comprising computer-executable instructions that when executed provide an output utilizing a pre-determined protocol (the utilization and conversion of said protocol will be discussed in more detail below). In the example shown, the electronic device 204 communicates with host protocol component 202 utilizing “SAS” (labeled as 203). In select embodiments, the electronic device is an electronic gaming device, such as an electronic slot machine operating under the SAS protocol (Slot Accounting System, commercially available from Innovative Gaming Technologies).

Further, while the above illustrative embodiment references the SAS protocol, any protocol may be utilized in accordance with the various embodiments of the invention.

Without being limited to specific protocols, exemplary protocols that may be utilized when communicating between the host protocol component 204 and the electronic device may comprise: BACTA (The British Amusement Catering Trade Association, see http://www.bacta.org.uk/index.php), BOB (Best of Breed, Gaming Standards Association, see http://www.gamingstandards.com); G2S (Game-to-System, Gaming Standards Association, see http://www.gamingstandards.com); S2S (System-to-System Gaming Standards Association, see http://www.gamingstandards.com), and QCOM (Queensland Local Area EGM Communications Protocol, controlled by the Queensland Office of Gaming Regulation).

In yet another embodiment, the electronic device is a video poker machine. In further embodiments, the electronic device may be an arcade-style amusement device. In any of the embodiments within the scope of the invention, the electronic device may be accessible by a user upon payment of a fee, such as through the use of tokens, tickets, vouchers, credits, and the like. In other embodiments, the electronic device may incorporate a gambling aspect, such as electronic devices in legal jurisdictions were wagering and/or gambling is permitted. In still yet further embodiments, however, the electronic device may be configured for personal gaming systems, such as Sony® Playstation® or Microsoft® Xbox®, an/or handheld systems such as a Palm® or Treo®, among others. Further, host protocol component 202 may comprise one or more computer-readable mediums, such as memory 205 for storing and executing computer-executable instructions for communicating with electronic device 204.

Returning to FIG. 2, protocol conversion system 200 comprises an engine protocol component 206 in communication with host device 208 utilizing a second protocol that is different than the first protocol, such as indicated with “BACTA” (207). Like host protocol component 202, the engine protocol component may comprise one or more computer-readable mediums, such as memory 209 for storing and executing computer-executable instructions for communicating with host 206.

As used throughout this disclosure, a “host device”, “host system”, or “host” is a computing device having at least a processor and a computer-readable medium having computer-executable instructions thereon that is configured to receive data from one or more electronic devices. As would be understood by one skilled in the art upon reviewing the present disclosure, the data received from the one or more electronic devices will vary among different embodiments. In one embodiment, the host system may further manipulate and/or utilize the data received from one or more electronic devices. In one such embodiment, the host system may aid in the determination of the outcome of a game played on the electronic device. In other embodiments, the host system may receive and manipulate accounting data, controls bonus and progressive play, tournaments and loyalty systems. In such embodiment, the host system provides some backroom functionality to the gaming operation.

As utilized throughout the Specification, communication between any device and/or component of the system 200 refers to both direct communication and indirect communication. Direct communication would include those embodiments where the information is transferred in compliance with the protocol utilized by the devices and/or components communicating. Such as where a connection directly links two or more components or devices, for example, such as linking through cables, such as with one or more RJ-45 cables. As one skilled in the art will readily appreciate, other cables and direct communication mediums are available and well-known in the art.

Gateway component 210 is operatively connected between the host protocol component 204 and the engine protocol component 206, wherein communications between the electronic device 202 and the host device 208 passes through the gateway component 210. Gateway component 210 comprises one or more computer-readable mediums 211, which may comprise, for example, ROM, flash memory, and/or removable media.

One or more computer-readable mediums 211 comprise computer-executable instructions that when executed perform one or more steps for that relate to configuration of one or more components of the system 200 and conversion of protocols between two or more components of the system 200. In select embodiments, host protocol component 202, gateway component 210, and engine protocol component 208 are within the same computing device. For example, all three components may be incorporated in computing device 100. Therefore, in one such embodiment, all components of the system may be within a single housing. Yet in other embodiments, host protocol component 202 may be positioned within electronic device 204 and engine protocol component may be positioned within host device.

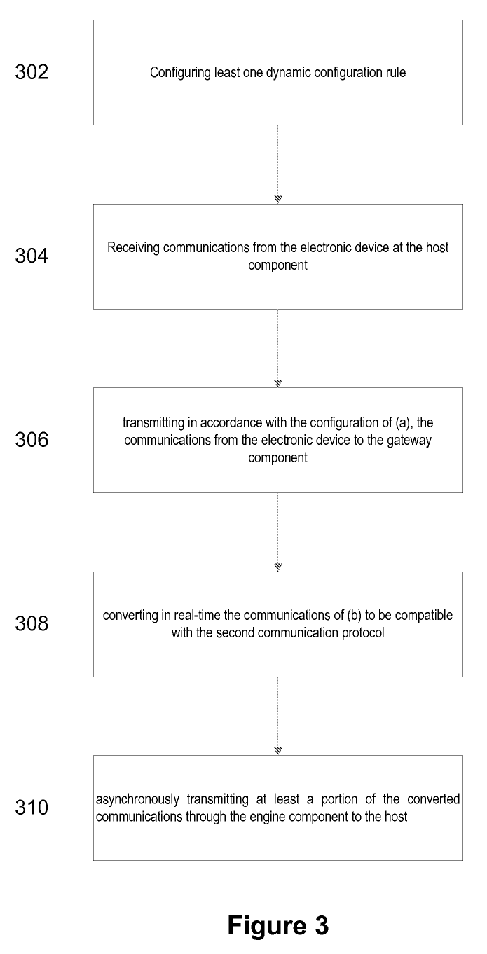

FIG. 3 is a flowchart of an illustrative computer-implemented method of converting protocols at a gateway device between at least one electronic device and a host according to one embodiment of the invention. As will be appreciated by one skilled in the art upon reading this disclosure, one ore more steps of the illustrative method may be omitted, rearranged in relation to other and/or additional steps, and/or altered without departing from the scope of the invention.

At step 302, at least one dynamic configuration rule is configured among the host protocol component and the engine protocol component. Configuration may also comprise the configuration of static operations, for example, the address of the component is with respect to its respective network is, along with other static parameters. One skilled in the art, however, will readily understand that under certain protocols, the address may be dynamic. Using SAS as an illustrative protocol, one type of dynamic configuration rule may be referred to as a trigger. Under the SAS protocol, triggers generally describe select operational characteristics of component. A trigger may be described as an operational behavior that is initiated by a stimulus, such as a timer, event, and/or response, and, in turn, performs a host-related behavior, such as, for example, querying for data, transmitting a command or the like. There are three defined trigger types in relation to the SAS Host.

The first, trigger, a timer trigger, is an operation that occurs at a specified interval, such as every 50 milliseconds. For example, in one embodiment, the bill verifier of a slot machine may be polled every 50 milliseconds to determine the amount of cash within the machine. As will be appreciated by those skilled in the art, converting information to communicate with a device operating with a different protocol that cannot poll every 50 milliseconds or receive information every 50 milliseconds would be challenging because simply converting the information to another protocol may prevent normal operation of the electronic slot machine.

The second trigger, an event trigger, is an operation that occurs because of an external stimuli acting upon the system. For example, if the electronic slot machine transmits a signal or message that indicates the cabinet door has opened, this external stimulus may trigger an operation to query the game for some of its meter values, such as querying the bill validator to determine the amount of currency within the machine.

The third trigger, a response trigger, allows the linking of operations together. For example, if an electronic slot machine is queried for some data, on receipt of that data, the component may be configured to request a different data element. By basing the dynamic behavior of the protocol components on triggers supplied by the gateway, different configurations may be utilized for different applications without mandating changes to the protocol component. As indicated by the term “dynamic”, the rules may be programmable and may be implemented with different parameters for different electronic devices. In one embodiment, the rules are stored in a volatile storage media, such as a flash drive, wherein the rules may be reloaded and/or altered every time the device is restarted and/or rebooted.

Yet in other embodiments, the system may be configured to allow the dynamic configuration rules to be updated in real-time during operation of the devices. As used herein, the term “operation” does not require a user to be using the machine, such as playing an electronic slot machine, rather the term “operation” is used to signify the state of the device is such it may transmit and/or receive an electronic signal or message. An electronic slot machine that is operating under software allowing a user to play the machine is “in operation”. This remains true even if the machine is currently running other computer-executable instructions, such as displaying an advertisement on a display or retrieving parameters from another computing device, such as retrieving an update. Further, if a machine is able to communicate with a gateway and/or a host device, this would be considered to allow utilization, and thus be considered operational.

At step 304, communications from the electronic device 204 may be received at the host component 202. For example, if the electronic device 204 is an electronic slot machine, the communication may comprise information that a player has wagered 1.5 British pounds. For such a wager under the SAS protocol, a single message is transmitted from the electronic device 204 through the host protocol component 202 to the gateway 206 for conversion to the second protocol. Unfortunately, the second protocol may not be configured to merely receive translated messages from the slot machine and merely forward the translated messages to the host.

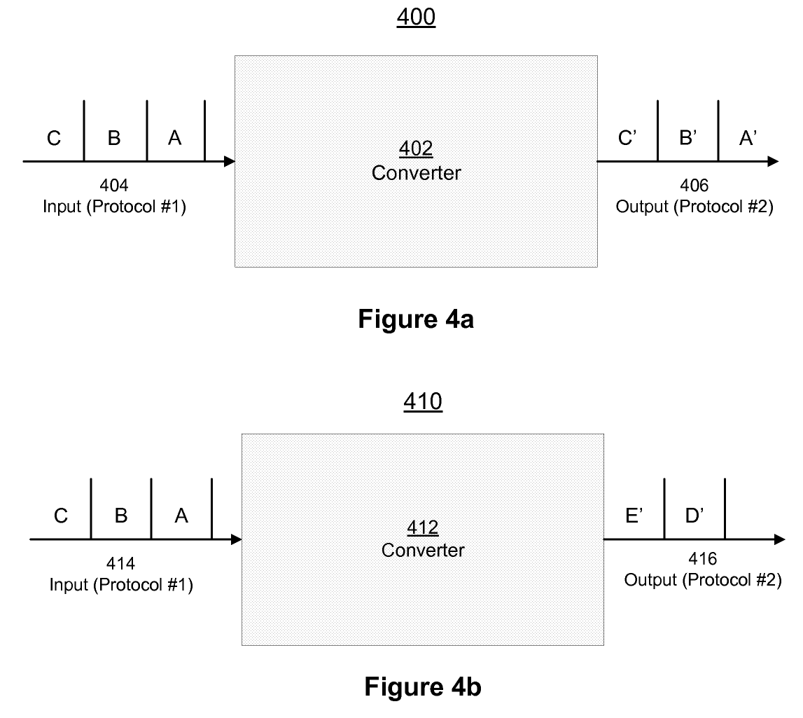

For example, looking briefly at the conversion system 400 of FIG. 4a, converter 402 receives an input 404 comprising messages “A”, “B”, and “C”. Converter 402 converts each message to a second protocol and provides and output comprising A′, B′, and C′, respectively. Thus, conversion system 400 is configured to receive communication in a first protocol and synchronously provide an output (406) in a second protocol. In contrast, conversion system 410 comprises converter 412 that may receive and/or transmit asynchronous messages among different protocols. As seen in the FIG. 4b, converter 412 receives input 414 comprising messages “A”, “B”, and “C”. Converter 412 converts each message to a second protocol and provides output 416 comprising D′ and E′. Thus, conversion system 410 is configured to receive communication in a first protocol and asynchronously provide an output in a second protocol. In the illustrated example, there is no corollary to messages A and B of input 414 in output 416. Thus, conversion system 410 may convert and asynchronously transmit messages to a second protocol. As explained in more detail below, the timing of the transmission of the messages may also be adjusted to further comply with the second protocol.

Returning to FIG. 2, embodiments showing novel aspects of one embodiment of a conversion system of the invention may be shown. As seen in FIG. 2, communications are transmitted in accordance with at least one dynamic configuration rule of step 302 from the electronic device 204 to the gateway component 210 (see step 306). At step 308, gateway 510 is configured to convert SAS communications 504 transmitted from an electronic slot machine, such as electronic device 204 to a host, such as host 202 utilizing the BACTA protocol. The communications may reach the gateway through a host API, such as host API 216. Unfortunately, as known by those skilled in one or more arts utilizing select embodiments of the invention, the BACTA protocol cannot merely translate the single message from the slot machine and forward the translated message to the BACTA host. In fact, the BACTA protocol is currently designed to only transmit wagering messages in increments of 10 pence. Thus, gateway 210 transmits 15 messages to the host 208, with each message indicating a wager of 10 pence. Thus, in this example, there is not a 1:1 ratio of messages received at gateway 210 with respect to the converted messages transmitted from electronic device 504.

Further, in the embodiment shown in FIG. 2, the reception and conversion of the communication from the slot machine and subsequent transmission of the converted message to the host occurs in real-time (see step 308). As used herein, the term “real-time” refers to a time-frame where the transmission of the communications (comprising electronic signals or messages) occurs without noticeable delay in operation of the electronic device 204. In one embodiment, the transmission occurs before a time out value determined by one of the two protocols. For example, if the SAS protocol requires a 20 millisecond response time, the system 200 may be configured to transmit, convert, and receive an electronic message from the electronic device 204 to the host device 208 with neither the electronic device nor the host device being aware of the gateway component. As such, the components of the system are configured to maintain the requirements of the various protocols with respect to performance, timing and other such requirements. In essence, all components and devices of the system will operate as if they are directly communicating with other components and devices utilizing the same protocol. Moreover, the system will operate without causing noticeable delay in the operation of the device 204.

Advantages of the illustrative embodiment may be more readily appreciated by utilizing a real-world example of an electronic slot machine operatively connected to a host device through a gateway. As seen in FIG. 2, gateway 210 is configured to convert SAS communications 203 transmitted from an electronic slot machine, such as electronic device 204 to a host, such as host 208 (step 310). As provided, gateway 210 may convert the communications to be compatible with the BACTA protocol. If the SAS communication comprises information that a player wagered 25 pence, a single message may be transmitted through the host protocol component to the gateway 512 for conversion. As previously mentioned, however, the BACTA protocol may only transmit wagering messages in increments of 10 pence. Thus even when converting the messages to the BACTA protocol and adjusting the number of messages based on the 10 pence unit scheme, there will be either 5 pence left over or an additional 5 pence will be indicated in the conversion. Embodiments of the present invention, however, address this issue.

Similar to the situation described in relation to system 410 of FIG. 4b, gateway 210 will receive the single SAS message relating to the wager of 25 pence. In this instance, however, the conversion process results in the production of two messages in the BACTA protocol, each indicating a unit of 10 pence has been wagered. In one embodiment, gateway 210 may store on a computer-readable medium, such as memory 211, the indication that an additional 5 pence was wagered.

This information may then be “piggybacked” onto subsequent messages transmitted to host 208. For example, if a player of the slot machine subsequently wagers 25 pence, gateway 210 may receive one message utilizing the SAS protocol and will convert the 25 pence wager into two messages or signals that each indicating a wager value of 10 pence. Gateway 210, however, may further combine the remaining 5 pence that was stored in the computer-readable medium 211 after being a remainder value of a previous wager and add it to the remaining 5 pence value that is the remainder of the present transaction. Therefore, an additional message or signal may be transmitted from gateway 210 utilizing BACTA (the second protocol) indicating a unit value of 10 pence was wagered.

As explained in the above examples, and shown by step 310 of FIG. 3, the gateway is configured to asynchronously transmit at least a portion of the converted communications to an engine protocol component, such as engine protocol component 206 to a host, such as host 208, wherein the transmission of the communications occur without neither the electronic device nor the host device being aware of the gateway component and without noticeable delay in operation of the electronic device.

In one embodiment, one or more dynamic rules may be transmitted from the gateway device to another component of the system for implementation distant from the gateway component, thus freeing resources at the gateway and/or lowering the traffic at the gateway. For example, if electronic device 204 routinely transmits the same data request through the host protocol component 202 to the gateway component 206 for conversion to a second protocol, it may be more efficient to free up resources on the gateway device by transmitting that particular dynamic rule to the host protocol component 202 for implementation. Therefore, the request may be received and responded to by the host protocol component 202 without requiring the gateway component 206 to convert the request to a second protocol and transmit the request to the host 208, and subsequently receive a response from the host 208 that must be converted back to the first protocol before being transmitted to the electronic device 204. This would be especially advantageous for requests where the response is generally constant.

In one embodiment, computer-readable medium 205 located in the host protocol component 202 comprises computer-executable instructions that when executed compare requests received from the electronic device 204 with predetermined requests, wherein upon determining that at least one request received from the electronic device matches at least one predetermined request, providing a response to the electronic device 204 without transmitting the request to the gateway component 210.

While the above exemplary embodiments demonstrate a direct connection between the various components of the system, further embodiments may utilize indirect communications between two or more components or devices. For example, for web-based applications that may be incorporated within or independent of cellular—based applications, the communication utilizing the protocol native between the two devices may be packetized or otherwise incorporated or imbedded into another protocol or platform for transfer. For example, if electronic device 202 is a slot machine utilizing the SAS protocol to communicate with the host protocol component 204, the communication may be achieved through a network, such as an intranet, or even through the Internet or cellular network, and thus may be transferred along with non-SAS compliant information through a different protocol, such as TCP/IP. Those skilled in the art will realize that there are an infinite number of possibilities of transferring the communication through an indirect connection.

In still yet further embodiments, more than one electronic device can each be in operative communication with a host protocol component, wherein each host protocol component communicates through the gateway component and the engine protocol component to a central host. Although there is only one central host for several electronic devices, each of the electronic devices operate as being in operative communication with different hosts despite communicating with the same host.

The present invention has been described in terms of exemplary embodiments. Numerous other embodiments, modifications and variations within the scope and spirit of the appended claims will occur to persons of ordinary skill in the art from a review of this disclosure. For example, one skilled in the art will appreciate different methods may be used to implement and configure the dynamic configuration rules without departing from the scope of the invention. Moreover, one or more steps of the described methods may be omitted or duplicated. Moreover, in some instance the steps may be performed in a different sequence than described above.

We claim:

1. A system comprising:
a host protocol component configurable to communicate with an electronic device utilizing a first protocol;
an engine protocol component configurable to communicate with a host device utilizing a second protocol; and
a gateway component configurable to be operatively connected between the host protocol component and the engine protocol component, wherein the gateway component comprises a computer-readable medium having computer-executable instructions that when executed perform the steps of:
(a) configuring at least one dynamic configuration rule;
(b) receiving communications from the electronic device at the host component during operation of the electronic device;
(c) transmitting in accordance with any configuration of (a), the communications from the electronic device to the gateway component;
(d) converting in real-time the communications of (b) to be compatible with the second communication protocol;
(e) asynchronously transmitting at least a portion of the converted communications through the engine component to the host, wherein the transmission of the communications occur without neither the electronic device nor the host device being aware of the gateway component and without noticeable delay in operation of the electronic device.

2. The system of claim 1, wherein the first protocol and the second protocol are selected from the group consisting of: SAS, BACTA, BOB, G2S, S2S, and QCOM, wherein the first protocol is different than the second protocol.

3. The system of claim 1, wherein the first protocol is SAS and the second protocol is G2S.

4. The system of claim 1, wherein the computer-executable instructions further comprise instructions for:
(f) determining that the at least one dynamic configuration rule is configured before implementing (b).

5. The system of claim 1, further comprising the step of:
(f) retaining at least a portion of the formatted communications of (d) in a computer-readable memory for a period of time before implementing (e).

6. The system of claim 1, wherein the at least one dynamic configuration rule is selected from the group consisting of: a timer trigger, an event trigger, and a response trigger.

7. The system of claim 1, wherein the host protocol component, the engine protocol component and the gateway component are located within a housing.

8. The system of claim 1, wherein a computer-readable medium located in the host protocol component comprises computer-executable instructions that when executed compare requests received from the electronic device with predetermined requests, wherein upon determining that at least one request received from the electronic device matches at least one predetermined request, providing a response to the electronic device without transmitting the request to the gateway component.

9. The system of claim 1, where in at least one communication within the system comprises an indirect communication.

10. The system of claim 1, wherein the first protocol is SAS and the second protocol is BACTA.

11. A computer implemented method comprising:
(a) configuring least one dynamic configuration rule for a host component that communicates with an electronic device utilizing a first communication protocol and an engine component that communicates with a host utilizing a second communication protocol, wherein the configuration is performed by a gateway component in communication with said host component and said engine component;
(b) receiving communications from the electronic device at the host component;
(c) transmitting in accordance with the configuration of (a), the communications from the electronic device to the gateway component;
(d) converting in real-time the communications of (b) to be compatible with the second communication protocol;
(e) asynchronously transmitting at least a portion of the converted communications through the engine component to the host, wherein the transmission of the communications occur without neither the electronic device nor the host device being aware of the gateway component and without noticeable delay in operation of the electronic device.

12. The method of claim 11, wherein a plurality of electronic devices are each in operative communication with a host protocol component, wherein each host protocol component communicates through the gateway component and the engine protocol component to the host, wherein each of the electronic devices operate as being in operative communication with different hosts despite communicating with the same host.

13. The method of claim 11, wherein the first protocol and the second protocol are selected from the group consisting of: SAS, BACTA, BOB, G2S, S2S, and QCOM, wherein the first protocol is different than the second protocol.

14. The method of claim 11, further comprising the step of:
(f) determining that (a) occurred before implementing (b).

15. The method of claim 1 1, further comprising the step of:
(f) retaining at least a portion of the formatted communications of (d) in a computer-readable memory for a period of time before implementing (e).

16. The method of claim 11, wherein the at least one dynamic configuration rule is selected from the group consisting of: a timer trigger, an event trigger, and a response trigger.

17. The method of claim 11, wherein the host protocol component, the engine protocol component and the gateway component are located within a unitary housing.

18. The method of claim 11, wherein (a) further comprises storing computer-executable instructions on a computer readable medium located in the host protocol component, that when executed compare requests received from the electronic device with predetermined requests, wherein upon determining that at least one request received from the electronic device matches at least one predetermined request, providing a response to the electronic device without transmitting the request to the gateway component.

19. A device comprising:
a protocol converter configured to receive communications in a first protocol transmitted from an electronic device, the protocol being further configured to convert in real-time the communications received to be compatible with a second protocol and asynchronously transmitting at least a portion of the converted communications in the second protocol to a host.

20. The device of claim 19, wherein the first protocol and the second protocol are selected from the group consisting of: SAS, BACTA, BOB, G2S, S2S, and QCOM, wherein the first protocol is different than the second protocol.
